(19) United States
(12) Patent Application Publication
(10) Pub. No.: US 2012/0089422 A1
(43) Pub. Date: Apr. 12, 2012

(54) GRAB-N-GO Emergency Portfolio for Critical Documents/Photos

(76) Inventor: Shirley A. Viehmann, La Mesa, CA (US)

(21) Appl. No.: 12/900,341

(22) Filed: Oct. 7, 2010

(51) Int. Cl. G06Q 40/00

(52) U.S. Cl. 705/4

(57) ABSTRACT

The GRAB-N-GO Emergency Portfolio for Critical Documents/Photos is a highly visible, comprehensive, organized and portable emergency portfolio containing your most critical documents and photos backed-up by a USB flash drive.

### BACKGROUND OF THE INVENTION

This product was designed utilizing the personal, and professional (medical/healthcare/biotechnology/personal finance) experience and background of the inventor. Its use is for emergency life events, i.e., wildfires, earthquakes, floods, etc., and/or evacuation, leaving a family legacy, or even moving to a different location. It is designed for personal and critical household documents in addition to personal and historical photos and for insurance claim purposes, if necessary. It is portable and easy to use in an emergency situation. Specific documents contained within this invention are emergency forms: Advanced Healthcare Directive, password sheet, address/contact sheets, and possible business referrals pertaining specifically to pertinence of subject matters contained within this organizational kit. It is a cost-effective means of replicating irreplaceable documents and photos that would otherwise be: 1) not replaceable at all, or, 2) saving thousands of dollars in replacement fees, time and energy, and loss, as well as negotiation/determination with insurance claims.

### BRIEF SUMMARY OF THE INVENTION

The GRAB-N-GO Emergency Portfolio for Critical Documents/Photos is a systematic and organized way to create a highly-visible, comprehensive, organized, and portable emergency portfolio for evacuation and/or other emergency events. The GRAB-N-GO Emergency Portfolio for Critical Documents/Photos is designed for clients/customers to scan and organize their most critical documents and photos. It is an easy-to-use organizational kit which provides the tools, blank forms, and specific instructions on how to best gather your critical information and preserve your irreplaceable documents and photos as well as document your home and household contents for personal and/or insurance purposes. It is a portable and cost-effective means of saving, and preserving, one's critical documents and photos in a comprehensive and organized manner. The USB Flash Drive included in the GRAB-N-GO Emergency Portfolio for Critical Documents/Photos cannot be password-encrypted and must be safeguarded carefully; warning regarding this matter is included. Customer must purchase a separate password-enabled USB Flash Drive, if desired.

The GRAB-N-GO Emergency Portfolio for Critical Documents/Photos is an organizational tool for emergency preparedness of critical documents and irreplaceable photos, and is differentiated from other products as there currently is no other product on the market designed to preserve critical household and personal documents, as well as irreplaceable photos, in such a comprehensive manner including the tools to back-up paper documents and paper photographs into electronic, and portable, formats. Its use is for emergency preparedness for evacuation or other life events, i.e., leaving a family legacy and vital information should any life events occur.

### DETAILED DESCRIPTION OF THE INVENTION

The GRAB-N-GO Emergency Portfolio for Critical Documents/Photos is an organizational tool for Emergency Preparedness of critical documents and irreplaceable photos, is differentiated from other products as there currently is no other product on the market designed to preserve critical household and personal documents, as well as irreplaceable photos, in such a comprehensive manner, including the tools to back-up paper documents and paper photographs into electronic, and portable, formats. Its use is for emergency preparedness for evacuation, wildfires, earthquakes, floods or other emergencies or other life events, i.e., leaving a family legacy and vital information should any life events occur.

Components of the GRAB-N-GO Emergency Portfolio for Critical Documents/Photos:

1. A pre-labeled highly-visible plastic Portfolio

2. 2GB Flash Drive with pre-loaded files, instructions, and forms

3. A Guide to the Basics of Gathering Your Documents

4. Detailed suggested Checklist

5. Emergency Contacts List form (blank)

6. Address Book form (blank)

7. Advanced Healthcare Directive form (blank)

8. Password Sheet form (blank)

9. 1 blank CD w/plastic sleeve (for Photo section)

10. 1 blank CD (outside pocket) w/paper sleeve for the insurance company (upload and burn photos of real estate property and contents of your home)

11. Business cards or information containing recommended resources may be included

The USB Flash Drive included in the GRAB-N-GO Emergency Portfolio for Critical Documents/Photos cannot be password-encrypted and must be safeguarded carefully; warning regarding this matter is included. Customer must purchase a separate password-enabled USB Flash Drive, if desired.

Instructions for using the GRAB-N-GO Emergency Portfolio for Critical Documents/Photos: User needs to utilize their own scanner and digitial camera. Then: 1) Review the Guide to Basics in Gathering Your Documents, 2) Review the GRAB-N-GO Emergency Portfolio Suggested Checklist and gather these documents, 3) Scan and organize them on to the flash drive included and into the Emergency Portfolio (paper originals or copies), 4) Fill out the Emergency Contact List; utilize the blank Address Book if needed, 5) Fill out the Advanced Healthcare Directive Form, and, 6) Fill out the Passwords sheet.

Utilizing the blank CD in the Photos section of the GRAB-N-GO Emergency Portfolio for Critical Documents/Photos, scan and organize photos and burn/copy these photos on to this blank CD and keep in the Photos section.

Then, utilizing their own digital camera, take photos of personal property and exterior of home; burn/copy these separately to the other blank CD (outside pocket) to make a claim with their personal insurance company, if necessary; place this CD in the paper sleeve provided, and turn over to the insurance company. The user should copy these photo files to the flash drive included (in to the respective pre-loaded electronic file folder) and/or the CD in the Photos section (for their back-up of the insurance photos taken). Business cards/information for recommended services may be included. A note to the user to not forget to SECURE both the Flash Drive and the GRAB-N-GO Emergency Portfolio for Critical Documents/Photos in separate locations.

The GRAB-N-GO Emergency Portfolio for Critical Documents/Photos detailed, suggested Checklist is as listed:

Advance Healthcare Directive

Auto insurance

Bank statement(s)

Birth certificate(s)

Contact List

Credit cards

Death records

Deed to house

Degrees

Dental records

Documentation of valuables

Drivers licenses

Durable Power-of-Attorneys (healthcare/financial)

Employment paystubs

Financial

Healthcare

Home insurance

Income tax returns (recent)

Irreplaceable photos

Legal documents

Licensures

Life insurance

Loans

Marriage license

Medical records (immunization card/medical/hospital records)

Medical Insurance Cards

Mortgage/Rental receipts

Net Worth statement

Ophthalmologist

Pay Stubs

Passport(s)

Passwords

Pink slip to auto(s)

Report Cards

Retirement statement(s)

School certificates

School-other

Social Security card(s)

Social Security Annual Statement

Stock statement(s)

Transcripts

Will(s) & Trust

This list is not all-inclusive; the user is advised to include other documents that are important to them and consult the advice of their personal attorney/financial planner.

The GRAB-N-GO Emergency Portfolio for Critical Documents/Photos is an organizational tool for Emergency Preparedness of critical documents and irreplaceable photos, and is differentiated from other products as there currently is no other product on the market designed to preserve critical household and personal documents, as well as irreplaceable photos, in such a comprehensive manner, including the tools to back-up paper documents and paper photographs into electronic, and portable, formats. Its use is for emergency preparedness for evacuation or other life events, i.e., leaving a family legacy and vital information should any life events occur.

1. There is no other highly-visible, comprehensively and organized organizational kit for emergency preparedness of critical documents and photos for personal and insurance use currently on the market like the GRAB-N-GO Emergency Portfolio for Critical Documents/Photos that is backed-up in an electronic format (currently a flash drive contained within this portfolio/kit), separated physically (paper documents) in an organized and comprehensive fashion and backed-up by electronic media. This product includes the electronic media with pre-loaded files, emergency forms, a very detailed list of what to consider gathering for inclusion in this emergency portfolio, and instructions on how to systematically gather and preserve this important household and insurance information in a very organized, easy-to-use, portable fashion for emergency purposes and/or evacuation. After thorough research of various other products, it is the inventor's belief that there are no other products of its kind with the ease, protection, both physical and electronic, comprehensively organized, and with the portability of the GRAB-N-GO Emergency Portfolio for Critical Documents/Photos.
